(19) United States
(12) Patent Application Publication
(10) Pub. No.: US 2019/0034009 A1
(43) Pub. Date: Jan. 31, 2019

(54) TOUCH PANEL DEVICE

(71) Applicant: FUJITSU COMPONENT LIMITED, Tokyo (JP)

(72) Inventors: Yutaka Ueno, Tokyo (JP); Satoshi Sakurai, Tokyo (JP); Tatsuro Hamano, Tokyo (JP); Masahiko Katayama, Tokyo (JP)

(21) Appl. No.: 16/032,262

(22) Filed: Jul. 11, 2018

(30) Foreign Application Priority Data
Jul. 31, 2017 (JP) 2017-148353

(51) Int. Cl. G06F 3/045; G06F 3/047

(52) U.S. Cl. CPC G06F 3/045; G06F 2203/04113; G06F 3/047

(57) ABSTRACT

A touch panel device includes an upper electrode layer; a decorative sheet attached to an upper surface side of the upper electrode layer and including a decorative portion; and an adhesive layer provided between the decorative sheet and the upper electrode layer within a range of the decorative portion and adhering the decorative sheet with the upper electrode layer.

### CROSS-REFERENCE TO RELATED APPLICATION

The present application is based on and claims the benefit of priority of Japanese Priority Application No. 2017-148353 filed on Jul. 31, 2017, the entire contents of which are hereby incorporated by reference.

### BACKGROUND

### 1. Field of the Invention

The present invention relates to a touch panel device.

### 2. Description of the Related Art

In a smartphone or a tablet-type terminal including a touch panel device, wirings and the like necessary for functioning the touch panel device are provided at an outside of a screen thereof. In order to hide such wirings, a structure is known in which a decorative sheet including printed decorations such as characters and patterns at an outer peripheral thereof is provided on a surface of a touch panel.

Such a decorative sheet may be attached to a surface of a touch panel device by adhering the decorative sheet over the entire surface of an upper electrode layer of the touch panel device (Patent Document 1, for example).

However, according to the method of adhering the decorative sheet over the entire surface of the upper electrode layer of the touch panel device, as the decorative sheet is fixed to the upper electrode layer and integrated with the upper electrode layer, the upper electrode layer becomes difficult to be deformed. Thus, operational feeling in a touch panel operation via the decorative sheet becomes heavy.

### PATENT DOCUMENT

### [Patent Document 1] Japanese Laid-open Patent Publication No. 2010-15200

### SUMMARY OF THE INVENTION

According to an embodiment, there is provided a touch panel device including an upper electrode layer; a decorative sheet attached to an upper surface side of the upper electrode layer and including a decorative portion; and an adhesive layer provided between the decorative sheet and the upper electrode layer within a range of the decorative portion and adhering the decorative sheet with the upper electrode layer.

### BRIEF DESCRIPTION OF THE DRAWINGS

Other objects, features and advantages of the present invention will become more apparent from the following detailed description when read in conjunction with the accompanying drawings.

FIG. 1 is a plan view of a touch panel device of a first embodiment;

FIG. 2 is a cross-sectional view of the touch panel device illustrated in FIG. 1 taken along a II-II line;

FIG. 3 is a cross-sectional view in which the vicinity of an adhesive layer of FIG. 2 is enlarged;

FIG. 4 is a cross-sectional view of a touch panel device of a second embodiment;

FIG. 5 is a view illustrating an example of a dot pattern;

FIG. 6 is a view illustrating another example of the dot pattern;

FIG. 7 is a view illustrating another example of the dot pattern;

FIG. 8 is a view illustrating another example of the dot pattern; and

FIG. 9 is a cross-sectional view of a touch panel device of a third embodiment.

### DESCRIPTION OF THE EMBODIMENTS

The invention will be described herein with reference to illustrative embodiments. Those skilled in the art will recognize that many alternative embodiments can be accomplished using the teachings of the present invention and that the invention is not limited to the embodiments illustrated for explanatory purposes.

In the drawings, the same components are given the same reference numerals, and explanations are not repeated.

### First Embodiment

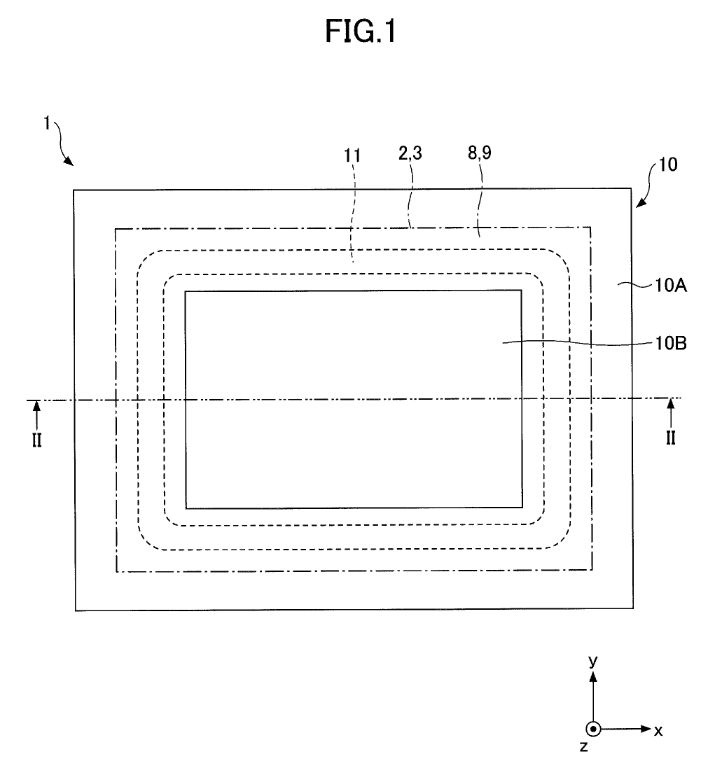

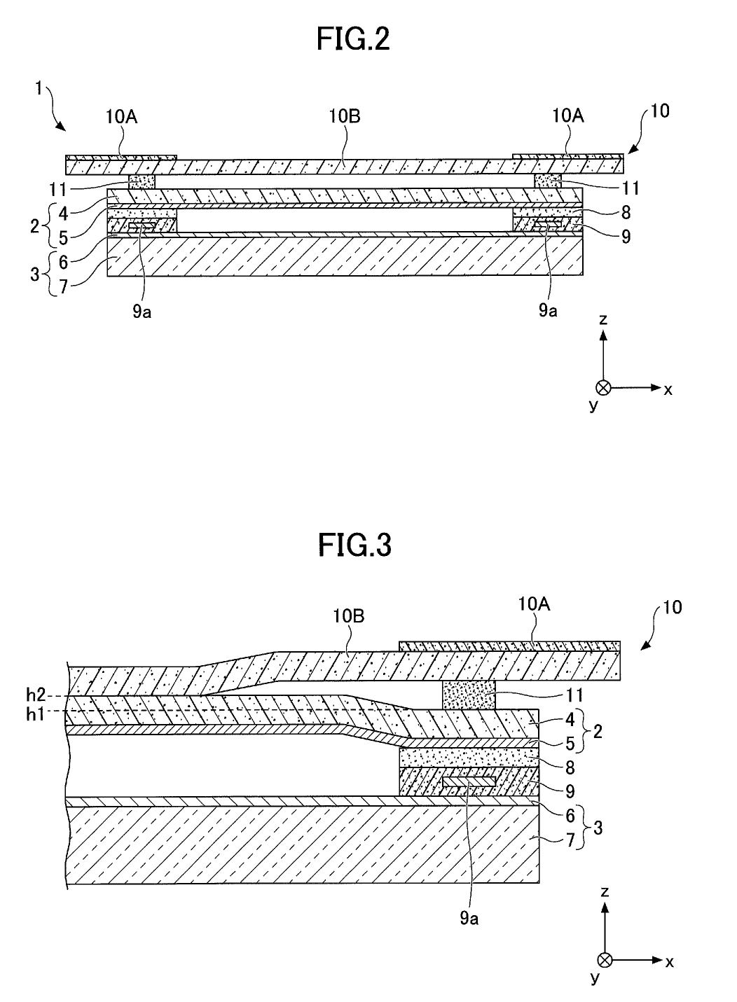

With reference to FIG. 1 to FIG. 3, a first embodiment is described. FIG. 1 is a plan view of a touch panel device 1 of the first embodiment. FIG. 2 is a cross-sectional view of the touch panel device 1 illustrated in FIG. 1 taken along a II-II line. FIG. 3 is a cross-sectional view in which the vicinity of an adhesive layer 11 of FIG. 2 is enlarged. The touch panel device 1 of the embodiment may be included in a smartphone, a tablet-type terminal and the like.

In each of the drawings, an x direction, a y direction and a z direction are perpendicular to each other. The z direction is a stacking direction of components of the touch panel device 1, and typically, is a vertical direction. Here, +z direction side is referred to as an upper side, and −z direction side is referred to as a lower side. Each of the x direction and the y direction are horizontal direction. The direction is an extending direction of two facing sides, among four sides, of a rectangular upper electrode layer 2 and a rectangular lower electrode layer 3. The y direction is an extending direction of the other two facing sides, among the four sides, of the upper electrode layer 2 and the lower electrode layer 3.

The touch panel device 1 is a resistive touch panel device. The resistive touch panel is configured, typically, to include a lower electrode layer with a transparent conductive layer and an upper electrode layer with a transparent conductive layer stacked on the lower electrode layer such that the transparent conductive layers are facing with each other.

The resistive touch panel is configured, typically, to have a function to detect a position at which the transparent conductive layers are contacted when force is applied on the upper electrode layer. The touch panel device 1 may by any type of the resistive touch panel device such as a four-wire type, a five-wire type and a seven-wire type.

As illustrated in FIG. 1 and FIG. 2, the touch panel device 1 includes a stacked structure of the lower electrode layer 3, a frame portion 9, an adhesive portion 8, the upper electrode layer 2, the adhesive layer 11 and a decorative sheet 10, that are stacked in this order.

The frame portion 9 includes wirings 9a and is provided between the upper electrode layer 2 and the lower electrode layer 3. The frame portion 9 is provided to overlap outer peripheries of the upper electrode layer 2 and the lower electrode layer 3, respectively, when seen in the z direction. The wirings 9a connect the upper electrode layer 2 and the lower electrode layer 3 with an external device.

The adhesive portion 8 such as a double sided tape is formed in a frame-like shape along the outer peripheries of the upper electrode layer 2 and the lower electrode layer 3, respectively, when seen in the z direction. The adhesive portion 8 adheres and fixes the upper electrode layer 2 with the lower electrode layer 3. Although the adhesive portion 8 is provided above the frame portion 9 in the first embodiment, the adhesive portion 8 may be provided below the frame portion 9. The adhesive portion 8 and the frame portion 9 may have substantially the same shape when seen in the z direction, and it is preferable that they are completely overlapped with each other.

As illustrated in FIG. 2, the lower electrode layer 3 includes a glass 7 as a base and a transparent conductive layer 6 provided at an upper side of the glass 7. The upper electrode layer 2 includes a film 4 as a base and a transparent conductive layer 5 provided at a lower side of the film 4. The upper electrode layer 2 is stacked on the lower electrode layer 3 such that the transparent conductive layer 5 and the transparent conductive layer 6 are facing with each other while interposing the adhesive portion 8 and the frame portion 9. Materials of the transparent conductive layers 5 and 6 may be, for example, ITO (Indium Tin Oxide).

The decorative sheet 10 is stacked at an upper surface side of the upper electrode layer 2. The decorative sheet 10 is a transparent sheet made of plastic, for example. The decorative sheet 10 is provided to cover the entire surface of the upper electrode layer 2. The decorative sheet 10 includes a transparent portion 10B at a center and a frame-like decorative portion 10A at an outer periphery of the decorative sheet 10.

The decorative portion 10A may be formed by a method such as printing at the outer periphery of the decorative sheet 10, and includes coloring, patterns, diagrams, characters and the like, for example. The decorative sheet 10 is provided for hiding the frame portion 9 of the touch panel device 1 by the decorative portion 10A so that the wirings 9a cannot be seen (recognized) from outside.

The adhesive layer 11 is provided between the upper electrode layer 2 and the decorative sheet 10. The adhesive layer 11 adheres and fixes a lower surface of the decorative sheet 10 and an upper surface of the upper electrode layer 2. The adhesive layer 11 is provided within a range of the decorative portion 10A to be overlapped with the decorative portion 10A, when seen in the z direction.

If the decorative sheet 10 is adhered to the entire surface of the upper electrode layer 2 in the touch panel device, the decorative sheet 10 is fixed to the upper electrode layer 2 and integrated with the upper electrode layer 2. In such a case, problems that the upper electrode layer 2 is difficult to be deformed, and the operational feeling in the touch panel operation becomes heavy may occur.

On the other hand, according to the touch panel device 1 of the first embodiment, the decorative sheet 10 is not adhered to the entire surface of the upper electrode layer 2 (specifically, the film 4), and only the decorative portion 10A is adhered to the upper electrode layer 2. In other words, the transparent portion 10B is not adhered to the upper electrode layer 2 and is not formed integrally with the upper electrode layer 2. The transparent portion 10B is a portion at which an operator of the touch panel device 1 touches for operation input. Thus, when the operator touches a touch panel via the decorative sheet 10 for operation, the above described problems that the upper electrode layer 2 is difficult to be deformed, and the operational feeling in the touch panel operation becomes heavy do not occur.

Further, a case is assumed in which a touch panel device is housed in an external housing, and a decorative sheet is adhered to an upper electrode layer at four sides of the decorative sheet by an adhesive. In such a case, a portion of the external housing is interposed between the upper electrode layer and the decorative sheet in addition to the adhesive. Thus, a thickness of an air space between the decorative sheet and the upper electrode layer is increased. Thus, a pressing amount necessary for operating the touch panel device is increased in accordance with the increased amount of the thickness of the air space formed between the decorative sheet and the touch panel device. Thus, operational feeling in a touch panel operation via the decorative sheet becomes heavy. Further, due to common differences of the touch panel device and the external housing, it is difficult to adjust the thickness of the air space. Thus, there is a limitation in improvement of the operational feeling.

On the other hand, according to the touch panel device 1 of the first embodiment, the decorative sheet 10 is directly attached to the film 4 of the upper electrode layer 2 only by the adhesive layer 11, and only the adhesive layer 11 is interposed between the decorative sheet 10 and the upper electrode layer 2. Thus, by adjusting the thickness of the adhesive layer 11, the thickness of an air space formed between the decorative sheet 10 and the upper electrode layer is easily made thin. With this, when performing the touch panel operation via the decorative sheet 10, increasing of the amount of pressing due to the increased thickness of the air space can be suppressed.

As described above, according to the touch panel device 1 of the first embodiment, when performing the touch panel operation via the decorative sheet 10, a phenomenon that the upper electrode layer 2 is hardly deformed due to attachment of the decorative sheet 10 can be prevented. Further, increasing of the amount of pressing necessary for the touch panel operation due to attaching the decorative sheet 10 can be suppressed as well. Thus, force and a pressing amount necessary for the touch panel operation can be reduced. Thus, the operational feeling of the touch panel operation can be made lightened. As a result, according to the touch panel device of the first embodiment, operational feeling in the touch panel operation via the decorative sheet 10 can be improved and smoother input operation can be actualized.

Further, in the touch panel device 1 of the first embodiment, the adhesive layer 11 is provided above the frame portion 9, in other words, within a range of the frame portion 9 when seen in the z direction. Here, the frame portion 9 hardly deforms by the operation input and is stable. Thus, according to the embodiment, the adhesive layer 11 is provided on the stable frame portion 9, not on the transparent portion 10B that deforms by the operation input. With this configuration, even when the decorative sheet 10 is pushed toward the adhesive layer 11 when attaching the decorative sheet 10, the adhesive layer 11 does not easily deform and the decorative sheet 10 can be surely and beautifully attached to the upper electrode layer 2.

Referring to FIG. 1, a dashed line indicates outer ends of the lower electrode layer 3, the upper electrode layer 2, the frame portion 9 and the adhesive portion 8. Dot lines indicate outer ends of the adhesive layer 11. As illustrated in FIG. 1, the adhesive layer 11 is provided over whole circumference of the decorative sheet 10 and the upper electrode layer 2, and a space between the decorative sheet 10 and the upper electrode layer 2 is sealed by the adhesive layer 11. With this, water or dusts are prevented from entering the space between the decorative sheet and the upper electrode layer 2, which is an operation input portion. Thus, an operation environment of the upper electrode layer 2 is stable, and the touch panel operation can be more stably performed.

The thickness of the adhesive layer 11 in the z direction may be 5 to 50 μm. The viscosity of the adhesive layer 11 may be greater than or equal to 3000 m Pa/s/(25° C.). The adhesive strength of the adhesive layer 11 may be greater than or equal to 20 N/25 mm. The width of the adhesive layer 11 may be greater than or equal to 1 mm. The material of the adhesive layer 11 may be thermosetting resin.

Further, as illustrated in FIG. 3, in the touch panel device 1 of the first embodiment, the upper electrode layer 2 is formed in a dome shape in which a center portion protrudes toward a decorative sheet 10 side. A protruding amount of the dome shaped upper electrode layer 2 (a difference between the highest point at the center “h2” and a height “hi” at the edge, of the upper electrode layer 2) may be determined based on the thickness of the adhesive layer 11. The protruding amount of the dome shaped upper electrode layer 2 may be 50 to 500 μm, for example.

With this, the air space between the upper electrode layer 2 and the decorative sheet 10 can be made as thin as possible by providing a space for providing the adhesive layer 11 at the periphery, while reducing a gap between the decorative sheet 10 and the film 4 at the center portion. With this, as the air space between the upper electrode layer 2 and the decorative sheet can be made furthermore thinner at the transparent portion 10B, which is the operation input portion at the center, operational feeling of the touch panel operation can be furthermore improved.

### Second Embodiment

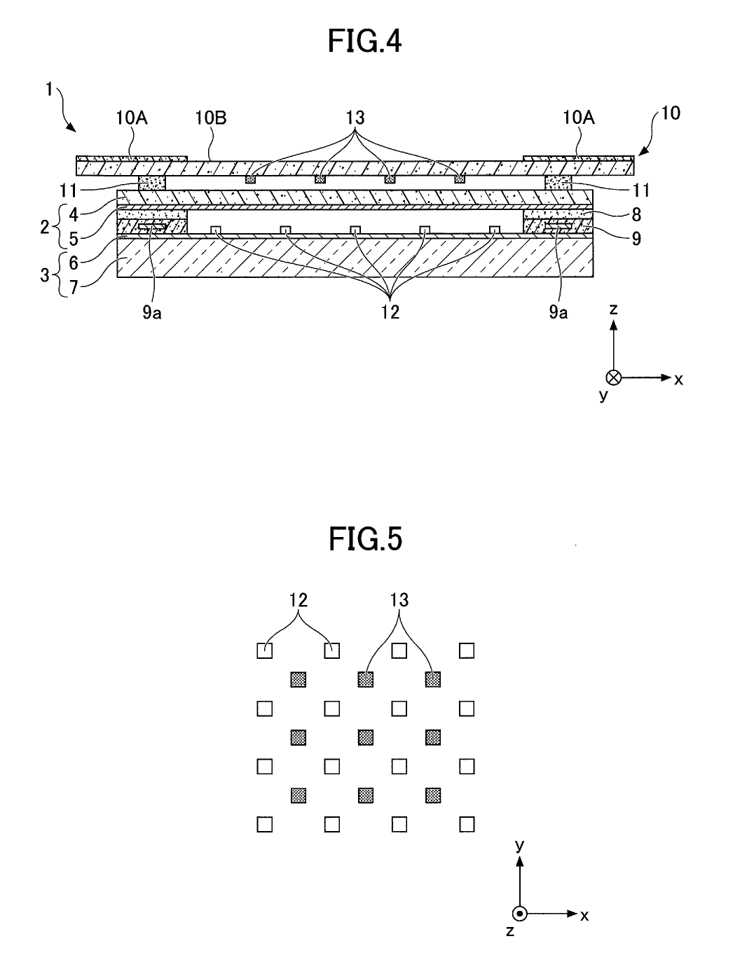

With reference to FIG. 4 to FIG. 8, a second embodiment is described. FIG. 4 is a cross-sectional view of the touch panel device 1 of the second embodiment. FIG. 5 is a view illustrating an example of a dot pattern.

As illustrated in FIG. 4, the touch panel device 1 of the second embodiment includes a plurality of dot spacers 12 provided between the upper electrode layer 2 and the lower electrode layer 3, for example. Specifically, the dot spacers 12 are provided at an upper surface of the transparent conductive layer 6 of the lower electrode layer 3, which faces a lower surface of the transparent conductive layer 5 of the upper electrode layer 2.

As illustrated in FIG. 5, the dot spacers 12 are provided at substantially even intervals in the x direction and in the y direction, respectively. The dot spacers 12 are made of a transparent resin material, for example. A size of the dot spacer 12 (a size in each of x and y directions) may be 10 to 200 μm, and a height of the dot spacer 12 (a size in the z direction) may be 5 to 500 μm. The dot spacers 12 are provided to separate the upper electrode layer 2 and the lower electrode layer 3 for avoiding accidental input, for example.

The touch panel device 1 of the second embodiment further includes a plurality of dots provided at a lower surface of the decorative sheet 10, which faces the film 4 of the upper electrode layer 2, at the transparent portion 10B other than the decorative portion 10A.

The dot 13 is a protrusion that protrudes from the lower surface of the decorative sheet 10 toward the upper electrode layer 2. A size and a height of the dot 13 are the same as those of the dot spacer 12, for example. Specifically, the size of the dot 13 (a size in each of x and y directions) may be 10 to 200 μm, and the height of the dot 13 (a size in the z direction) may be to 500 μm. Similarly as the dot spacers 12, the dots 13 are made of a transparent resin material, for example. Similarly as the dot spacers 12, the dots 13 are provided at substantially even intervals in the x direction and in the y direction, respectively.

As illustrated in FIG. 5, each of the dots 13 may be provided at a center of the four dot spacers 12, which is a center position in the x direction and also a center position in the y direction, for example.

By providing such dots 13 at the decorative sheet 10, the upper electrode layer 2 is more easily deformed when pressing the decorative sheet 10. In other words, a deforming amount of the upper electrode layer 2 when pressing the decorative sheet 10 is increased by providing the dots 13. Thus, the upper electrode layer 2 can easily contact the lower electrode layer 3 when pressing the decorative sheet 10, and operational feeling in the touch panel operation can be furthermore lightened.

Further, in the second embodiment, the dots 13 are provided not to overlap the dot spacers 12 in a planar view. If the dots 13 are provided to overlap the dot spacers 12, respectively, when an operator presses a position of the decorative sheet 10 at which the dot 13 is provided to overlap the dot spacer 12, the upper electrode layer 2 cannot be pressed anymore toward the lower electrode layer 3 after contacting the dot spacer 12. In such a case, operational feeling of the touch panel operation is worsened by the dots 13 and the dot spacers 12. Further, as the upper electrode layer 2 cannot contact the lower electrode layer 3 due to the dot spacer 12, the input operation cannot be detected. By providing the dots 13 not to overlap the dot spacers 12 in a planar view, these problems can be avoided.

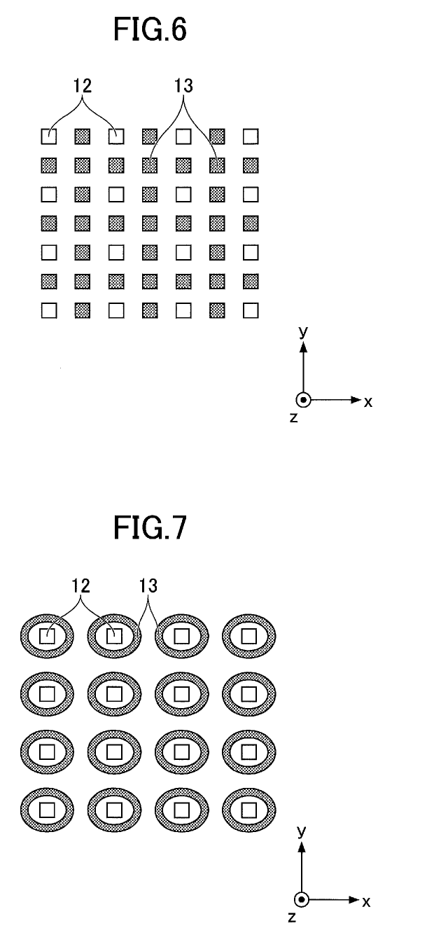

FIG. 6 to FIG. 8 are views each illustrating another example of the dot pattern.

As illustrated in FIG. 6, in addition to the dots 13 illustrated in FIG. 5, the dots 13 may be provided at a center position of the two dot spacers 12, which are adjacent to each other in the x direction, in the x direction, and at a center position of the two dot spacers 12, which are adjacent to each other in the y direction, in the y direction, respectively.

Alternatively, as illustrated in FIG. 7, the dot 13 may be formed in a circular shape that surrounds each of the dot spacers 12.

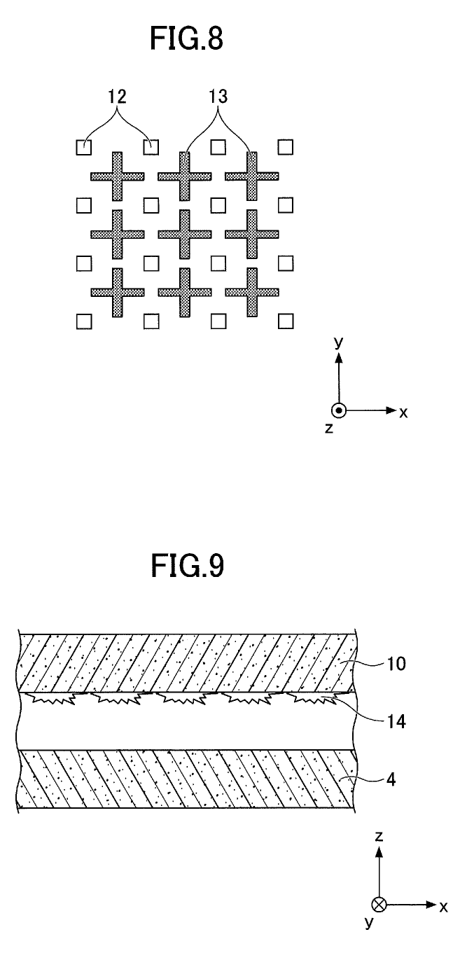

Alternatively, as illustrated in FIG. 8, the dot 13 may be formed in a cruciform provided at a center of the four dot spacers 12 such that to extend in the x direction at a center position of the dot spacers 12 in the y direction, and extend in the y direction at a center position of the dot spacers 12 in the x direction, respectively.

Here, as long as the dots 13 are provided between the decorative sheet 10 and the upper electrode layer 2, the dots 13 may be provided at the upper surface of the upper electrode layer 2 to protrude from the upper surface, instead of being provided at the decorative sheet 10.

### Third Embodiment

With reference to FIG. 9, a third embodiment is described. FIG. 9 is a cross-sectional view of the touch panel device 1 of the third embodiment. In the third embodiment, the touch panel device 1 is configured similarly as that of the first embodiment except the following points.

In the third embodiment, grain finishing is performed on the lower surface of the decorative sheet 10. The grain finishing may be performed over the entirety of at least the lower surface of the transparent portion 10B of the decorative sheet 10. The grain finishing is a surface treatment for forming a wrinkling pattern (grain) at a surface of an object. For example, the grain finishing may be actualized by applying transparent resin including fillers on the lower surface of the decorative sheet 10.

As a result of performing the grain finishing, as illustrated in FIG. 9, a wrinkling pattern 14 is formed at the lower surface of the decorative sheet 10.

When both of the decorative sheet 10 and the film 4 of the upper electrode layer 2 are clear type films, as the decorative sheet 10 and the film 4 are provided to be close to each other, a Newton ring may be generated due to interference of light. The Newton ring is easily generated when an amount of a gap between two facing films is small, and also the amount of the gap between the films is not constant.

In order to prevent generation of the Newton ring, a non-glare type film may be used for either one of the decorative sheet 10 and the film 4. The non-glare type film is a film on which a surface treatment for preventing reflection of light is performed, and has a haze value higher than that of a clear type film. The haze value means percentage of diffused light with respect to total transmittance. The larger the haze value is, the weaker the reflection of light becomes. However, if a non-glare type film is to be used, choices for a material are reduced, and cost for the material may be increased. Thus, it is desirable to prevent generation of the Newton ring even when clear type films are used for both of the decorative sheet 10 and the film 4.

In the third embodiment, the decorative sheet and the film 4 may be made of clear type films. Then, in the third embodiment, by performing the grain finishing on the lower surface of the decorative sheet 10 to form the wrinkling pattern 14, the surface roughness of the lower surface of the decorative sheet 10 that faces the film 4 can be increased, and the haze value of the decorative sheet 10 can be increased as well. With this, even when both of the decorative sheet 10 and the film 4 are clear types, generation of the Newton ring can be prevented. Thus, it is unnecessary to use a non-glare type sheet, and options of the materials of the decorative sheet 10 and the film 4 can be increased.

Here, the grain finishing may be performed on the upper surface of the film 4 of the upper electrode layer 2 to form a wrinkling pattern on the film 4, or may be performed on both of the lower surface of the decorative sheet 10 and the upper surface of the film 4. Generation of the Newton ring can be prevented by performing the grain finishing at least on one of the lower surface of the decorative sheet 10 and the upper surface of the film 4.

According to the disclosure, a touch panel device capable of improving operational feeling in a touch panel operation via a decorative sheet can be provided.

Although an embodiment of the touch panel device has been specifically illustrated and described, it is to be understood that minor modifications may be made therein without departing from the spirit and scope of the invention as defined by the claims.

The present invention is not limited to the disclosed embodiments, and numerous variations and modifications may be made without departing from the spirit and scope of the present invention. The placement, material, condition, shape, size and the like of each component are not limited to the described examples, and may be appropriately modified. Further, components described in different embodiments or examples may be partially substituted by each other, or combined with each other.

Although it is exemplified in the above embodiment that the film 4 is used as the base of the upper electrode layer 2 on which the transparent conductive layer 5 is formed, and the glass 7 is used as the base of the base of the lower electrode layer 3 on which the transparent conductive layer 6 is formed, other materials may be used for the bases of the upper electrode layer 2 and the lower electrode layer 3, respectively.

Although it is exemplified in the above embodiment that the adhesive layer 11 is provided within a range of the frame portion 9, this is not limited so. As long as the adhesive layer 11 is provided within the range of the decorative portion 10A of the decorative sheet 10, the adhesive layer 11 may not be provided within the range of the frame portion 9.

Further, although it is exemplified in the above embodiment that the width of the adhesive layer 11 is narrower than those of the adhesive portion 8 and the frame portion 9 (see FIG. 1, for example), the adhesive layer 11 may be formed to have a width same as those of the adhesive portion 8 and the frame portion 9.

Although it is exemplified in the above embodiment that the adhesive layer 11 is provided over the whole circumference of the decorative sheet 10 and the upper electrode layer 2, and that a portion between the decorative sheet 10 and the upper electrode layer 2 are sealed by the adhesive layer 11, this is not limited so. The adhesive layer 11 may be only provided at a portion of the outer peripheries of the decorative sheet 10 and the upper electrode layer 2. In such a case, the portion between the decorative sheet 10 and the upper electrode layer is not sealed.

Although it is exemplified in the above embodiment that the upper electrode layer 2 has the dome shape in which the center portion protrudes toward the decorative sheet 10 side, the upper electrode layer 2 may be formed to have a flat shape.

Further, the dot spacers 12 may be provided in the touch panel device 1 of each of the first embodiment and the third embodiment.

What is claimed is:

1. A touch panel device comprising:
an upper electrode layer;
a decorative sheet attached to an upper surface side of the upper electrode layer and including a decorative portion; and
an adhesive layer provided between the decorative sheet and the upper electrode layer within a range of the decorative portion and adhering the decorative sheet with the upper electrode layer.

2. The touch panel device according to claim 1, wherein the decorative sheet is provided to cover the entire surface of the upper electrode layer.

3. The touch panel device according to claim 1, wherein the decorative portion is provided at an outer periphery of the decorative sheet over whole circumference of the decorative sheet.

4. The touch panel device according to claim 3, wherein the adhesive layer is formed over whole circumference of the decorative sheet and the upper electrode layer such that a portion between the decorative sheet and the upper electrode layer at a center is sealed by the adhesive layer.

5. The touch panel device according to claim 1, wherein the upper electrode layer is formed in a shape in which a center portion protrudes toward a decorative sheet side.

6. The touch panel device according to claim 1, further comprising:
a lower electrode layer on which the upper electrode layer is stacked;
a plurality of dot spacers provided between the upper electrode layer and the lower electrode layer; and
a plurality of dots each protrudes from at least one of a lower surface of the decorative sheet and an upper surface of the upper electrode layer,
wherein the dots are provided not to overlap the dot spacers, in a planar view.

7. The touch panel device according to claim 1, wherein grain finishing is performed on at least one of a lower surface of the decorative sheet and an upper surface of the upper electrode layer.
